(19) United States
(12) Patent Application Publication
(10) Pub. No.: US 2005/0136220 A1
(43) Pub. Date: Jun. 23, 2005

(54) Methods of producing recording sheets having reduced curl

(76) Inventors: Chang Park, San Diego, CA (US); Christine E. Steichen, Escondido, CA (US); Mark Drake, Temecula, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/742,114

(22) Filed: Dec. 19, 2003

(51) Int. Cl. B32B 3/00

(52) U.S. Cl. 428/156; 428/172; 264/171.13; 264/210.2; 156/209

(57) ABSTRACT

The present invention relates to recording sheets and methods of producing recording sheets. In one embodiment, a method for producing a print medium includes extruding a polymer to form a polymeric layer. The polymeric layer is attached to a substrate and a pattern is formed in the polymeric layer. In another embodiment, a recording sheet having a substrate and a means for reducing curl of the recording sheet is disclosed. A method for reducing curl of a recording sheet is also disclosed. The method includes providing a recording sheet having a substrate and an embossed polymeric layer attached to a surface of the substrate. A cross machine direction stiffness of the recording sheet is enhanced in order to reduce curl of the recording sheet.

### FIELD OF THE INVENTION

The present invention relates generally to recording sheets. More specifically, the invention relates to recording sheets for use in image-forming apparatuses and methods of producing the recording sheets.

### BACKGROUND OF THE INVENTION

The use of digital image-forming apparatuses such as, for example, thermal ink-jet printers, large-format plotters, piezo-electric printers, large form plotters, laser printers, silver halide grade photo imaging apparatuses, and others has grown in recent years. The growth may be attributed to substantial improvements in print resolution and overall print quality coupled with appreciable reduction in cost. Today's image-forming apparatuses offer acceptable print quality for many commercial, business and household applications at costs lower than those offered in the past.

Media products for receiving printed images are used in conjunction with these image-forming apparatuses. Known imaging and printing media often include a base substrate, i.e., a type of paper, coated with a single or multi-layer functional polymer coating. The polymeric coating may enhance the deposition of the ink onto the media, prevent smearing of the image formed on the media or protect the media from abrasion, spills, or other image-degradation effects. However, if the media includes two or more individual polymeric layers and the polymeric layers possess different thermal, hygroscopic or other environmental properties, any environmental change may generate a resultant force between the polymeric layers and, thus, cause the media to curl.

The intensity or the radius of the curl depends on the modulus of the individual coating layers, the differences in dimensional changes of the polymeric layers and the stiffness of the materials used in the substrate. The media typically curls more in a weaker direction. Curl is an important quality criteria for printing and imaging media since curling of the media may cause feeding failure of the media into the image-forming apparatus, crushing of print-heads used by the image-forming apparatus, or mis-registering of the media into the image-forming apparatus.

Conventional print media has a lower modulus in the cross machine direction (CD) than the machine direction (MD) due to the nature of cellulosic fibrous composites, polymer films, and the manufacturing conditions used to manufacture the print media. The ratio of MD to CD stiffness may be two or higher. Accordingly, the axis of curl that typically affects the print media occurs along the CD direction (i.e., the print media curls in the CD direction). Known print media are characterized by MD and CD stiffness parameters that are coupled together, wherein the enhancement of CD stiffness also enhances and, thus, is limited by the MD stiffness. If the MD stiffness becomes too high, printer feeding failure may result.

### BRIEF SUMMARY OF THE INVENTION

In one embodiment, a method for producing a print medium is disclosed. The method includes extruding a polymer to form a polymeric layer and attaching the polymeric layer to a first surface of a substrate. A three-dimensional pattern is formed on the polymeric layer.

In another embodiment, a recording sheet having reduced curl is described. The recording sheet includes a substrate having a first surface and an opposing, second surface. A means for reducing curl of the recording is attached to a first surface of the substrate.

A method for reducing curl of a recording sheet is further disclosed. The method includes providing a recording sheet having a substrate and at least one embossed, polymeric layer attached to at least one surface of the substrate. The method further includes balancing the stiffness of the machine direction and the cross machine direction to reduce curl of the printing system.

### BRIEF DESCRIPTION OF THE DRAWINGS

While the specification concludes with claims particularly pointing out and distinctly claiming that which is regarded as the present invention, the advantages of the invention may be more readily ascertained from the following description of the invention when read in conjunction with the accompanying drawings in which:

FIG. 1 illustrates a top view of one embodiment of a recording sheet of the present invention;

FIG. 2 is a cross-section of the recording sheet of FIG. 1;

FIG. 3 is a schematic diagram of one embodiment of an extrusion system of the present invention;

FIG. 4 illustrates a schematic diagram of one embodiment of a cast film extrusion system of the present invention;

FIG. 5 depicts one embodiment of an extrusion coating system of the present invention;

FIG. 6 is a schematic diagram of one embodiment of an extrusion lamination system of the present invention;

FIG. 7 is a schematic diagram of another embodiment of an extrusion lamination system of the present invention

FIG. 8 is a perspective view of another embodiment of a recording sheet of the present invention;

FIG. 9 is a cross-section of another embodiment of a recording sheet of the present invention; and

FIGS. 10-14 illustrate computer models of various embodiments of recording sheets of the present invention.

### DETAILED DESCRIPTION OF THE INVENTION

A recording sheet, or print medium, and method of producing recording sheets suitable for use in an image-forming apparatus such as, for example, an inkjet-printer, a large-format plotter, a piezo-electric desktop printer, a large-form plotter, a laser printer, a silver halide grade photo imaging apparatus, or any other image-forming apparatus are described.

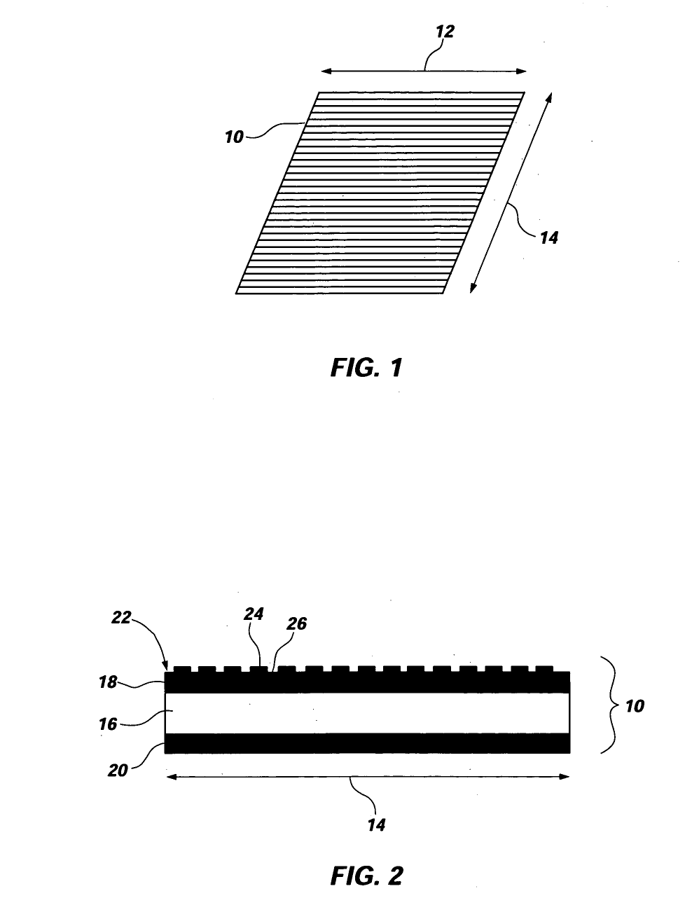

Referring to FIG. 1, there is shown a top view of one embodiment of a recording sheet of the present invention generally at 10. A cross machine direction (CD) of the sheet 10 is illustrated with arrow 12 and a machine direction (MD) is illustrated with arrow 14. It will be apparent by those of ordinary skill in the art, that although FIG. 1 illustrated the CD direction with arrow 12 and the MD direction with arrow 14, the CD direction and the MD direction may be interchangeable depending on the method of converting, i.e., the method of separating individual recording sheets 10 from a larger roll of recording sheet material.

FIG. 2 illustrates a cross-section of the recording sheet 10 of FIG. 1. The recording sheet 10 includes a substrate 16 and a means for reducing curl of the recording sheet, such as, for example, an embossed layer 18 having a three-dimensional pattern formed thereon, wherein the embossed layer 18 enables the recording sheet 10 to resist curling. By producing the embossed layer 18 and balancing axial stiffness of the recording sheet 10, MD and CD stiffness may be independently controlled and decoupled, thus reducing curl of the recording sheet 10. The embossed layer 18 enables CD stiffness (which is typically the curl-generating direction) to be enhanced without influencing the MD stiffness. Accordingly, the CD curl of the recording sheet 10 may be reduced without effectuating printer feeding failure.

The recording sheet 10 also includes at least one ink absorbent layer 20 for receiving ink. In another embodiment, the recording sheet 10 may have an ink absorbent layer on each side, i.e., a double sided recording sheet. In another embodiment, the embossing may be done in a direction on the recording sheet 12 to enable MD stiffness to be enhanced, while the CD stiffness is not influenced.

The substrate 16 of the recording sheet 10 may be porous throughout, it may be nonporous throughout, or it may comprise both porous and nonporous regions. Further, the substrate 16 may be substantially transparent, substantially opaque or the substrate 16 may be of intermediate transparency.

Examples of porous substrate materials that may be used to form the substrate 16 include, without limitation, paper, paperboard, synthetic fiber composite, wood, cloth, nonwoven fabric, felt, unglazed ceramic material, polymeric membranes, porous foam, microporous foam or any combinations thereof. The porous substrate material may be coated or laminated to render one or more surfaces substantially nonporous, thus, providing substrates having at least one substantially nonporous surface.

Examples of substantially nonporous substrates that may be used to form the substrate 16 include, but are not limited to, sheets or films of organic polymer such as, for example, poly(ethylene terephthalate), polyethylene, polypropylene, cellulose acetate, poly(vinyl chloride), thermoset organic polyers, copolymers such as saran, or any combinations thereof. The recording sheet 10 may be metallized or unmetallized. Examples of metallized sheets include metal substrates, including, without limitation, aluminum foil and copper foil. Other examples of nonporous substrates include porous or microporous foams comprising a thermoplastic organic polymer, wherein the foam has been compressed to such an extent that the resulting deformed material is substantially nonporous. Yet another example is a substrate including glass.

The ink absorbent layer 20 of the recording sheet 10 may also include or be coated with materials that increase the adhesion of inkjet dyes or pigments to the recording sheet 10, optimize image quality, increase resistance to scratches, increase resistance to air fading, increase resistance to moisture, increase resistance to UV light, and/or provide a matte finish, a textured finish, or a glossy finish. Such materials include, but are not limited to, gelatin, alumina, silica, calcium carbonate, clay, polyvinyl pyrrolidone, cellulosic polymers, methylhydroxyl propyl cellulose, polyvinyl alcohol, polyesters, polystyrenes, polystyrene-acrylic, polymethyl methacrylate, polyvinyl acetate, polyolefins, poly(vinylethylene-co-acetate), polyethylene-co-acrylics, amorphous polypropylene and copolymers, graft copolymers of polypropylene, or any combinations thereof.

In the embodiment of FIG. 2, the embossed layer 18 has the pattern formed on an upper surface 22 of the recording sheet 10. In one embodiment, the pattern includes upper areas 24 and lower areas 26, i.e., peaks and valleys, wherein the upper areas 24 and the lower areas 26 are substantially planar. The upper areas 24 are substantially parallel to the lower areas 26 and extend across a substantial width in the CD direction 12 of the recording sheet 10. Although the embodiment of FIG. 2 has been described with an exemplary pattern, the exemplary pattern is illustrative and it will be apparent by those of ordinary skill in the art that the pattern may comprise any pattern that decouples the CD 12 stiffness from the MD 14 stiffness.

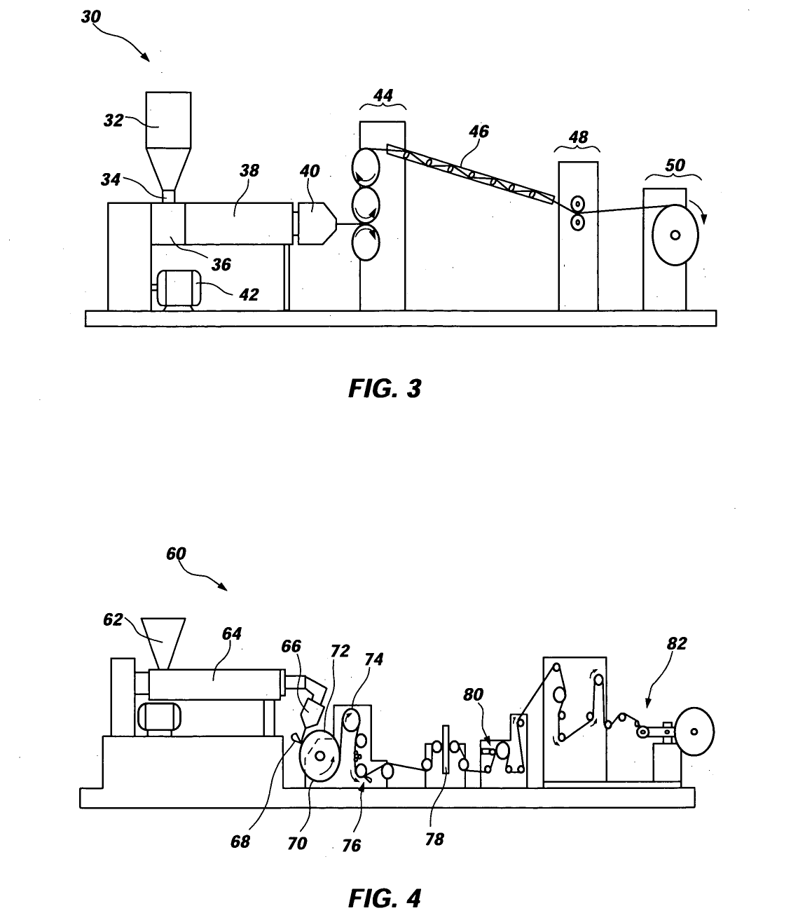

The embossed layer 18 may be produced using an extrusion process, a hot melt process, or any combination thereof. Referring now to FIG. 3, there is illustrated one embodiment of an extrusion system, such as a sheet or flat film extrusion line that may be used to form the embossed layer 18 of the recording sheet 10 of FIG. 2, shown generally at 30. The extrusion system 30 includes a hopper 32 for holding a material used to form the embossed layer 18. In one embodiment, the material used to form the embossed layer 18 comprises polyolefin. In other embodiments, the material used to form the embossed layer 18 may comprise any other polymer including, without limitation, cellulose based polymers and polyethylene, polystyrene, polypropylene, ethylene/vinyl acetate copolymer, ethylene acrylic acid, ethylene methyl acrylic acid, acid copolymer, ethylene vinyl alcohol copolymer, polyester, polyamides, polycarbonate, polyurethane, any extrusible materials. The extrusion system 30 further includes a reducer 34 that feeds the polyolefin into a feed throat 36. The polyolefin in transported to a barrel 38 wherein the polyolefin is conditioned to appropriate conditions for extruding the polyolefin through a die 40. The die 40 extrudes the polyolefin to form the extruded polyolefin. The extrusion system 30 is powered by a motor 42.

The extruded polyolefin is transferred from the die 40 to a three roll stack 44 that transports the extruded polyolefin to a cooling section 46 such that the extruded polyolefin may be cooled and the appropriate pattern set into the extruded polyolefin. The pattern may be imparted on the extruded polyolefin with the die 40 or with one of the three rollers of the three roll stack 44. The cooled, extruded polyolefin passes through nip rolls 48 and is wound on a winder 50, wherein the cooled, extruded polyolefin may be attached to a substrate, such as by laminating, to form the embossed layer 18.

Referring now to FIG. 4, there is illustrated another embodiment of a system 60, such as a cast film extrusion line, that may be used to form the embossed layer 18. The system 60 includes a hopper 62 for holding the material used to form the embossed layer 18. In one embodiment, the material comprises polyolefin, but in other embodiments may comprise any other known polymer including, but not limited to, cellulose based polymers and polyethylene. The system 60 further includes an extruder 64 for preparing the polyolefin for passage through a film die 66. Once the extruded polyolefin exits the film die 66, it passes an air knife 68 that directs the extruded polyolefin around a chill roll 70. An outer surface 72 of the chill roll 70 is embossed with a pattern and used to form a pattern on one side of the extruded polyolefin. The patterned, extruded polyolefin passes over a stripping roll 74 and through an edge trim slitter 76 where the patterned, extruded polyolefin is sized and shaped.

A thickness of the patterned, extruded polyolefin is monitored with a thickness scanning system 78. The patterned, extruded polyolefin passes through a surface treatment element 80 that treats the patterned surface of the extruded polyolefin for subsequent attachment to a substrate. The patterned, extruded polyolefin is then wound with a winder 82 for subsequent incorporation into a recording sheet.

In other embodiments, the pattern may be formed on the embossed layer 18 with any mechanical, chemical or optical patterning process known in the art, including, without limitation, etching and laser ablation. The mechanical, chemical or optical patterning methods may be used to form the pattern in the embossed layer 18 after an extrusion coating process or a film extrusion/lamination process.

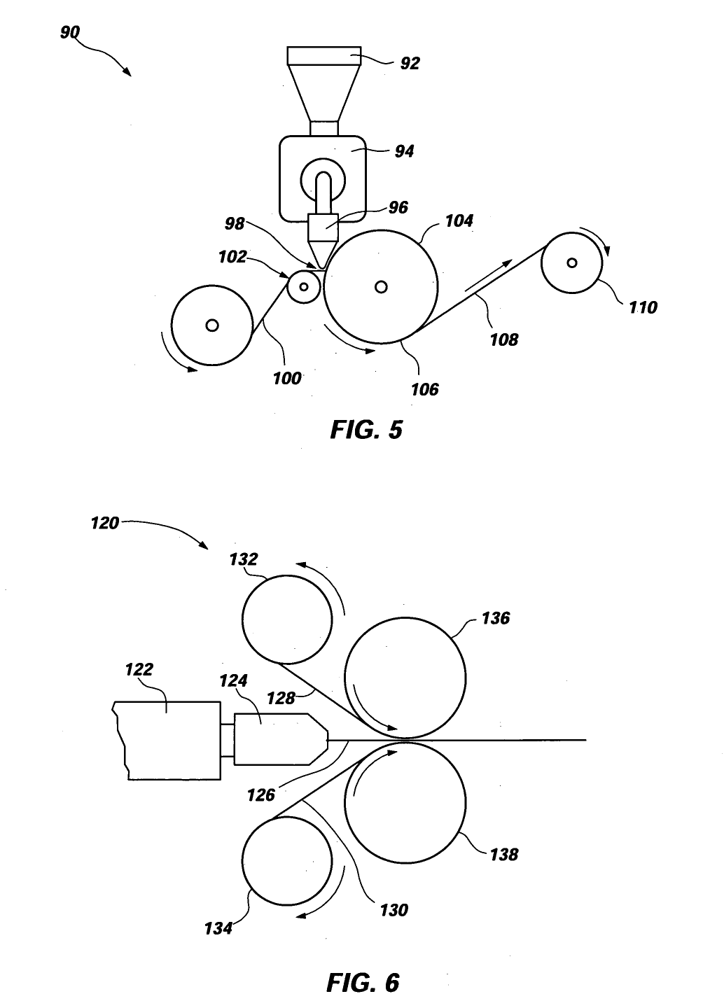

The recording sheet 10 may be produced with an extrusion coating process, an extrusion/lamination process, or a combination thereof. In one embodiment, the recording sheet 10 is produced with the extrusion coating process where a polymer layer is attached to a substrate to form the recording sheet. Referring now to FIG. 5, there is illustrated one embodiment of an extrusion coating system 90 that includes a hopper 92 for holding material used to form the embossed layer 18 of the recording sheet 10. In one embodiment, the material is polyolefin, but may comprise other polymeric substances including, without limitation, polyethylene and cellulose based polymers. The extrusion coating system 90 also includes an extruder 94 for preparing the polyolefin material for passage through a film die 96.

After the extruded polyolefin passes through the film die 96, the extruded polyolefin is laminated to an uncoated substrate 100 with a pressure roll 102. The uncoated substrate 100 may comprise any porous or non-porous substrate as previously described herein, such as, for example, a cellulose fiber network composite. The pressure roll 102 applies pressure to the extruded polyolefin and the uncoated substrate 100 between the pressure roll 102 and a chill roll 104. The chill roll 104 has a pattern embossed on an outer surface 106 of the chill roll 104 such that a pattern may be imparted to the extruded polyolefin as the extruded polyolefin is laminated to the uncoated substrate 100. A coated substrate 108 comprising the substrate and the extruded polyolefin is released from the chill roll 104 and is wound on a wind-up roll 110 for subsequent processing. The coated substrate 108 may be further processed, dimensioned and cut into sheets, such as the recording sheet 10 of FIG. 1.

FIG. 6 illustrates one embodiment of an extrusion lamination system 120 that includes an extruder 122 for preparing a polymeric material, such as polyolefin, for extrusion through a die 124. As extruded polyolefin 126 exits the die 124, the extruded polyolefin 126 is laminated to a first layer 128 and a second layer 130. The first layer 128 is unwound from a first roll 132 and the second layer 130 is unwound from a second roll 134. An upper nip roll 136 and a lower nip roll 138 provide pressure for the lamination process. The first layer 128 and the second layer 130 may be any type of conventional layer used to form recording sheets, including, but not limited to, imaging layers, ink receiving layers, polymeric layers, substrates, anti-curl layers, stacking layers, or any combinations thereof.

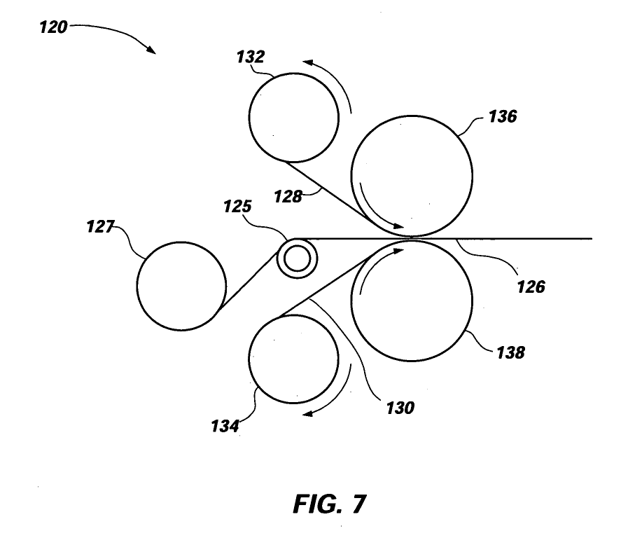

FIG. 7 illustrates another embodiment of an extrusion lamination system 120 that is substantially similar to the extrusion lamination system of FIG. 6. In the extrusion system 120 of FIG. 7, the extruded polyolefin 126 may be pre-formed and supplied on a supply roll 127, wherein the extruded polyolefin 126 is directed between the upper nip roll 136 and the lower nip roll 138 by a positioning or tension roller 125.

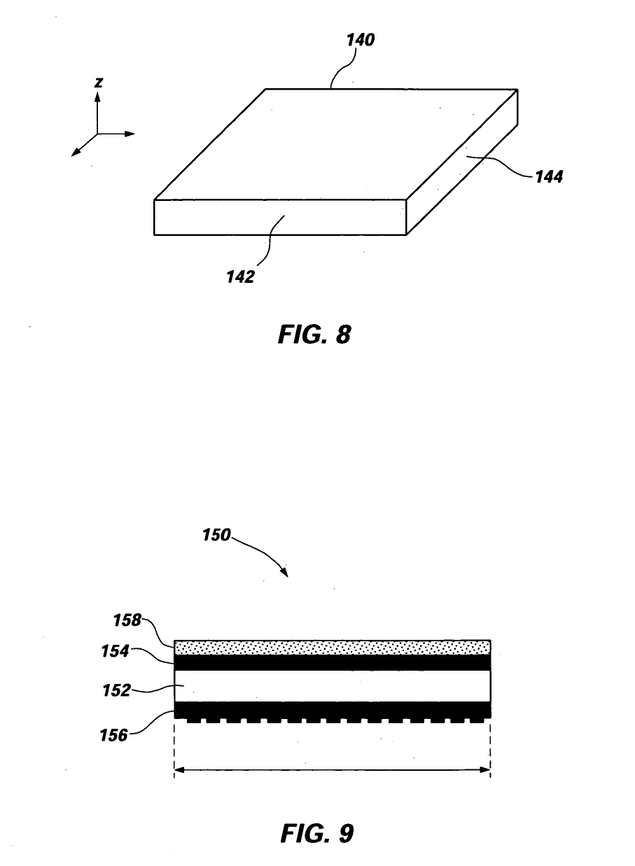

Referring now to FIG. 8, a perspective view of a media used to model different embossing patterns and showing x, y and z coordinates is illustrated at 140. Symmetry boundary conditions in the y direction are indicated at 142 and symmetry boundary conditions in the x direction are indicated at 144. The y-component variations and the x-components are fixed.

FIG. 9 illustrates a cross-section of another embodiment of a recording sheet 150 produced using the methods of the present invention. The recording sheet 150 includes a substrate layer 152, a non-embossed polymer layer 154, an embossed polymer layer 156 and an image receiving layer 158. The substrate layer 152 can be porous throughout, nonporous throughout or any combination thereof as previously described herein with regard to the recording sheet 10 of FIG. 2. The non-embossed polymer layer 154 and the embossed polymer layer 156 can be polyolefin, but may alternatively comprise any other known polymers including, for example, cellulose based polymers and polyethylene. The image receiving layer 158 can be gelatin, but may alternatively comprise any other ink receiving material as described herein with regard to the recording sheet 10 of FIG. 2.

A finite element based computational tool is used to simulate the curl behavior of recording sheets produced using methods of the present invention. By varying the size and spacing of a pattern of the embossed polymer layer 156, dimensions of the pattern formed on the embossed polymer layer 156 are optimized in order to reduce curl of the recording sheet 150. The finite element based computational tool is a conventional method to analyze static and dynamic structural analysis of the recording sheet 150.

The properties of the polymer layers 154 and 156 in combination with the substrate layer 152 used in the computer modeling are listed in Table 1. The properties of the ink receiving layer 158 used in the computer modeling are depicted in Table 2.

TABLE 1

| | | | | | | | Shear | Shear | Shear |
|---|---|---|---|---|---|---|---|---|---|
| | Young's | Young's | Young's | Poisson | Poisson | Poisson | Modulus, | Modulus, | Modulus, |
| | Modulus, x | Modulus, y | Modulus, x | Ratio, υ_{xy} | Ratio, υ_{yz} | Ratio, υ_{zx} | G_{xy} | G_{yz} | G_{zx} |
| Polymer | 14000000000 | 1000000000 | 7000000000 | 0.3 | 0.3 | 0.3 | 10000000 | 10000000 | 1000000 |
| Layer/ | Pa | Pa | Pa | | | | Pa | Pa | Pa |
| Substrate | | | | | | | | | |
| Composite | | | | | | | | | |

TABLE 2

| Normalized | | | Thermal |
|---|---|---|---|
| Environmental | | Poisson | Expansion |
| Condition | Young's Modulus | Ratio | Coefficient |
| 0 | 5500000000 Pa | 0.3 | 0.0015 |
| 0.25 | 4800000000 Pa | 0.3 | 0.0015 |
| 0.5 | 4500000000 Pa | 0.3 | 0.0015 |
| 0.75 | 3500000000 Pa | 0.3 | 0.0015 |
| 1 | 1400000000 Pa | 0.3 | 0.0015 |

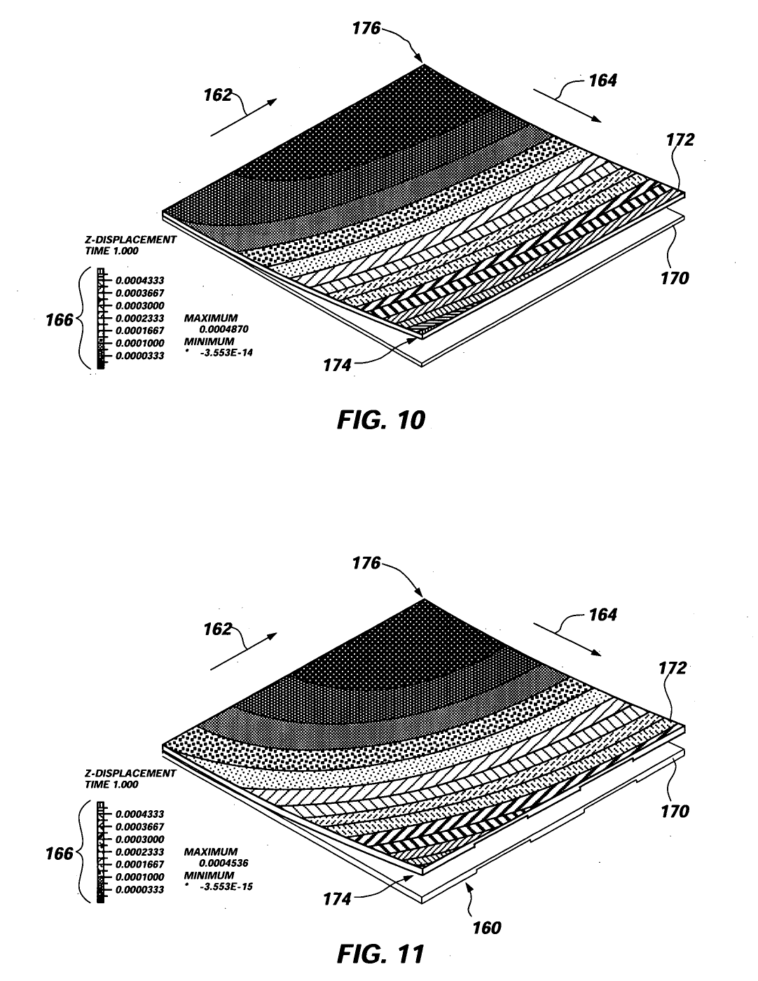

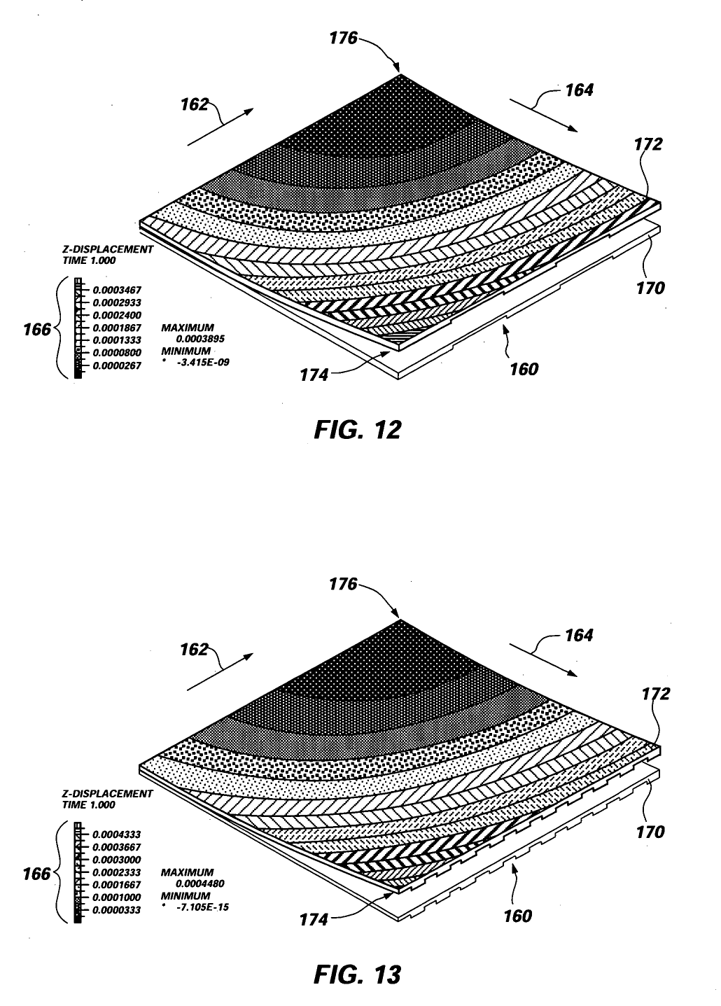

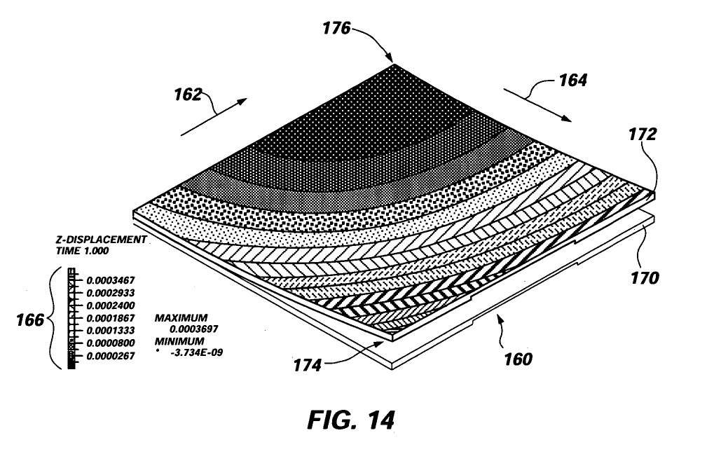

FIGS. 10-14 illustrate modeled displacements in the z direction of various recording sheets using the finite element based computational tool. FIG. 10 represents a model of a control recording sheet that does not include an embossed layer. FIGS. 11-14 represent models of recording sheets that each includes a means for reducing curl such as, for example, an embossed, patterned layer having a pattern, wherein the shape and spacing of the pattern is varied as illustrated along a lower edge 160 of the computer model. The MD direction is illustrated by arrow 162 and the CD direction is illustrated by arrow 164.

Each of FIGS. 10-14 depicts a recording sheet 170 at time 0 and a stressed recording sheet 172 at time 1.000 that is subjected to varying environmental conditions, including, but not limited to, temperature changes or humidity changes. The stressed recording sheet 172 is illustrated with varying shades of gray, which represent varying distances (indicated with scale 166) that areas of the stressed recording sheet 172 move in relation to the recording sheet 170 being subjected to varying environmental conditions. The changing environmental conditions cause resultant forces of various layers of the stressed recording sheet 172 to change and, thus, to “curl.” A maximum distance that the stressed recording sheet 172 moves in relation to the recording sheet 170 is represented at 174 and a minimum distance is represented at 176.

Simple experimentation will enable one of ordinary skill in the art to determine the appropriate combination and thickness of the various layers of recording sheets and of the type and the pattern of the embossed layers to minimize displacements of the recording sheet 170 in relation to a stressed recording sheet 172, as depicted in FIGS. 10-14. Thus, an appropriate combination of the depth and width between peaks and valleys of the pattern can be modeled as described herein in order to reduce curl of the recording sheet such that printing errors and printing abnormalities may be avoided.

Although the present invention has been shown and described with respect to various embodiments, various additions, deletions and modifications that are obvious to a person of ordinary skill in the art to which the invention pertains, even if not shown or specifically described herein, are deemed to lie within the scope of the invention as encompassed by the following claims.

1. A method for producing a print medium, the method comprising:
extruding a polymer to form a polymeric layer;
attaching the polymeric layer to a first surface of a substrate; and
forming a three-dimensional pattern on the polymeric layer.

2. The method according to claim 1, further comprising attaching at least one ink absorbent layer to the substrate.

3. The method according to claim 1, wherein:
attaching the polymeric layer to the first surface of the substrate comprises placing a hot melt of the polymeric layer on the first surface of the substrate; and
forming the three-dimensional pattern on the polymeric layer comprises:
forming the three-dimensional pattern to be applied on the polymeric layer on a chill roll; and
embossing the three-dimensional pattern on the polymeric layer with the chill roll.

4. The method according to claim 1, wherein:
forming the three-dimensional pattern on the polymeric layer comprises:
forming the three-dimensional pattern to be applied on the polymeric layer on a chill roll; and
embossing the three-dimensional pattern on the polymeric layer with the chill roll; and
attaching the polymeric layer to the first surface of the substrate comprises laminating the polymeric layer having the embossed, three-dimensional pattern to the first surface of the substrate.

5. The method according to claim 1, wherein forming the three-dimensional pattern on the polymeric layer comprises a mechanical, chemical or optical patterning process.

6. The method according to claim 1, further comprising attaching a second polymeric layer to an opposing, second surface of the substrate.

7. The method according to claim 1, wherein forming the three-dimensional pattern on the polymeric layer comprises forming peaks and valleys in the polymeric layer, wherein the peaks and the valleys run substantially parallel to each other and extend a substantial width of the print medium.

8. A recording sheet, comprising:
a substrate having a first surface and an opposing, second surface; and
a means for reducing curl of the recording sheet, wherein the means for reducing curl is attached to the first surface of the substrate.

9. The recording sheet of claim 8, further comprising at least one ink receiving layer attached to the opposing, second surface.

10. The recording sheet of claim 8, wherein the means for reducing curl comprises an embossed, polymeric layer having a three-dimensional pattern formed in a surface thereof.

11. The recording sheet of claim 10, wherein the embossed layer comprises a polymer and the three-dimensional pattern comprises alternating peaks and valleys.

12. The recording sheet of claim 11, wherein the alternating peaks and valleys are parallel to a width of the recording sheet.

13. The recording sheet of claim 11, wherein the polymeric layer comprises polyolefin, a cellulose based polymer, polyethylene, or any combination thereof.

14. The recording sheet of claim 8, further comprising an embossed, polymeric layer attached to the opposing, second surface of the substrate.

15. The recording sheet of claim 8, wherein the substrate is selected from the group consisting of paper, paperboard, wood, cloth, nonwoven fabric, felt, unglazed ceramic material, polymeric membranes, porous foam, microporous foam, poly(ethylene terephthalate), polyethylene, polypropylene, cellulose acetate, poly(vinyl chloride), thermoset organic polymers, saran, aluminum foil, copper foil, a thermoplastic organic polymer, compressed foam, or any combinations thereof.

16. The recording sheet of claim 9, wherein the ink receiving layer is selected from the group consisting of gelatin, alumina, silica, calcium carbonate, clay, cellulosic polymers, methylhydroxyl propyl cellulose, polyesters, polystyrenes, polystyrene-acrylic, polymethyl methacrylate, polyvinyl acetate, polyolefins, poly vinyl alcohol, polyvinyl pyrrolidine, poly(vinylethylene-co-acetate), polyethylene-co-acrylics, amorphous polypropylene and copolymers, graft copolymers of polypropylene, or any combinations thereof.

17. The recording sheet of claim 8, wherein a cross machine direction stiffness of the recording sheet is de-coupled from a machine direction stiffness of the recording sheet.

18. A method for reducing curl of a recording sheet, the method comprising:
providing a recording sheet having a substrate and at least one embossed polymeric layer attached to at least one surface of the substrate; and
balancing the stiffness of a machine direction and a cross machine direction to reduce curl of the printing system.

19. The method according to claim 18, further comprising attaching an ink receiving layer to at least one surface of the substrate.

20. The method according to claim 18, wherein enhancing the cross machine direction stiffness comprises applying an embossed, three-dimensional pattern to the at least one polymeric layer.

21. The method according to claim 20, further comprising modeling different embossed, three-dimensional patterns to determine an appropriate shape of the embossed, three-dimensional pattern.

22. The method according to claim 18, wherein the at least one embossed polymeric layer comprises a three-dimensional pattern formed therein.

23. The method according to claim 18, wherein balancing the stiffness of the machine direction and the cross machine direction to reduce curl of the printing system comprises enhancing the cross machine direction stiffness of the recording sheet, wherein enhancing the cross machine direction stiffness does not affect the machine direction stiffness of the recording sheet.
